(19) United States
(12) Patent Application Publication
(10) Pub. No.: US 2022/0396422 A1
(43) Pub. Date: Dec. 15, 2022

(54) INJECTOR ASSEMBLY FOR SEALING LEAKS ON BOLTED TANKS AND METHOD OF USING SAME

(71) Applicant: KBA Industries Limited, Mississauga (CA)

(72) Inventors: George Nicholas BOJECZKO, Springwater (CA); Robert Gordon KIRK, Hagersville (CA)

(21) Appl. No.: 17/343,836

(22) Filed: Jun. 10, 2021

(51) Int. Cl. B65D 90/22

(52) U.S. Cl. CPC B65D 90/22

(57) ABSTRACT

The injector assembly device disclosed herein provides a rapid and inexpensive way to seal leaks in bolted tanks, without having to drain the tank. Leaks occur over time either between the overlapping tank panels, around the tank bolts or a combination of both. It is a very costly and time-consuming process to drain tanks in order to repair such leaks. The device disclosed can therefore find application specifically in field of bolted tanks, but also in numerous different applications when a water tight seal is required between two pieces of material that are bolted together.

### FIELD OF THE INVENTION

The present invention relates generally to the field of devices to seal tank leaks, specifically injector assemblies for sealing leaks in bolted tanks, more specifically injector assemblies for sealing leaks in bolted tanks without having to drain the tanks.

### BACKGROUND

U.S. Pat. No. 9,803,792 (Wang) discloses a system and method of sealing leaks. The system and method related to process piping and equipment without process shutdown by providing a clamp having a cavity surrounding a leaking structure, sealant equipment comprising an injection gun to inject a sealant into the clamp cavity, means for pressuring moldable sealant from the gun into the clamp cavity in a staged manner beginning at a point away from the leak site.

U.S. Pat. Appl. No. 2013/0264774 (Bailor Carey) discloses a flange joint and method for preventing a fluid from leaking out through a flange joint. The method comprises forming a partial barrier in an outer part of a flange joint, applying a sealant to the outside of the flange joint, and supplying a safe sealing fluid to an inner part of the flange joint, prevents a process fluid from leaking out through a flange joint, advantageously without having to dismantle the flange joint.

U.S. Pat. Appl. No. 2010/0139185 (Neighbors) discloses an elevated water tank including bolted panel support pedestal. The elevated water tank utilizes an integrated field erected and bolted panels, such as, by way of example, steel rolled tapered panels having epoxy powder-coated construction. The outer bolted steel reinforced panels are integral and co-linear with the preferably cylindrically shaped exterior reservoir walls there above providing reservoir perimeter structural support. water tank having a bolted panel support pedestal which may be mass produced and having the ability for safe an efficient construction in the field. Such an elevated tank can use an integrated bolted panel support pedestal and elevated water reservoir, or a bolted panel support pedestal below a tank or reservoir of different construction.

U.S. Pat. No. 2,560,092 (Griffin) discloses a sealing means for bolted tanks. Storage tanks used in the oil industry, are fabricated by overlapping and bolting together a plurality of arcuate sheets or staves. Sealing gaskets are arranged between the overlapping edges of the sheets and bolts are employed for securing the sheets together in clamping relationship with the gaskets to provide leak-proof joints. It is a feature of the present construction that it seals any possible leak around the bolt at the possible source of the leak, these sources being from under the bolt head, or from between the channel and the sheet, and then in either case along the threads of the bolt. To stop such leaks, it is the usual procedure after the bolt is inserted and prior to installing the nut, to push a rubber ring over the end of the bolt against the tank sheet, and then to place a conical washer over the bolt against the rubber ring. When the nut is then tightened, the washer is flattened and the material of the rubber ring is forced into the hole of the sheet.

U.S. Pat. No. 7,624,760 (Monk) discloses a liquid tank puncture-repair method. A structure-aided method for sealing, from the outside, a liquid-leaking puncture wound in the wall of a liquid container. This method is implemented utilizing a patch body having a perimetered cavity selectively securable to the outside of such a container with the cavity overlying and facing the wound, and the cavity's perimeter surrounding the wound, and a patch pellet confined in the cavity, and possessing a liquid-reaction substance which, with the patch body secured to the container, reacts to contact with liquid leaking from the container at least by imbibing such liquid and swelling to apply wound-sealing pressure, and more preferably by additionally reacting with leakage liquid to form a sticky coagulant mass for aiding in applying sealing pressure to the wound. The patch body may be employed directly on the outside of a container, or with an intermediate, resilient gasket which centralizes the symmetrical introduction of leakage liquid into the pellet-containing cavity.

U.S. Pat. No. 2,817,218 (Stirling) discloses a method for stopping leaks in tanks. The method of stopping leaks in tanks and has for one object, to provide a convenient and reliable method of stopping a leak in a tank wherein the metal outer wall is insulated from the contents of the tank by an insulating lining of such character that a cold boiling liquid contained within the tank is kept by the insulation out of contact with the outer tank wall or shell. Another material that might be used to plug the leak is carbon dioxide. Carbon dioxide gas freezes to a solid or Dry Ice at temperatures far above the temperature of methane. If carbon dioxide is forced into the lining at the leak, it will penetrate the leak, resist outward flow of the cold boiling liquid, will readily penetrate the pores of the lining about the leak and will congeal to form a plug filling the leak and sealing the area in the porous lining around the leak.

U.S. Pat. No. 9,933,103 (Fink) discloses an apparatus and method for sealing a leak from a tubular member. The apparatus for sealing a leak from a tubular member has a channel member with at least one open end, a sealing member positioned in an interior of the channel member and having a channel extending therethrough, and a compression assembly having a portion extending through the channel of the sealing member. The compression assembly also has a rotatable element extending outwardly of the channel of the sealing member. The rotatable element is rotatable so as to compress or deform the sealing material within the interior of the channel member so as to seal the leak. A tape material is wrapped over the channel member so as to fix a position of the channel member over the leak.

JP. Pat. No. 2001/323522 (Kajiyama) discloses a water leak prevention method for water tank or reservoir and water leak prevention applied to water tank or reservoir. It is possible to completely and for a long time prevent water leakage from a water tank or a reservoir formed of metal such as concrete, wood, steel, plastic, glass, soil, etc. It is also an object of the present invention to provide an easy and inexpensive water leakage prevention method and a water tank or a reservoir provided with water leakage prevention. An inner surface of a water tank or a reservoir is covered with a corrosion-resistant metal sheet. Here, it is preferable that the corrosion-resistant metal sheet is a titanium sheet or a titanium alloy sheet. Further, it is preferable that the ends of the corrosion-resistant metal sheet are joined by a resistance welding method.

CN. Pat. No. 104449563 (Guodong) discloses a sealant for blocking leakage under pressure. The invention discloses a sealant for blocking leakage under pressure. The sealant is prepared from the following components in percentage by weight: 10-30% of a base material, 10-20% of a curing agent, 10-15% of a retarder, 10-20% of a filler, 10-15% of a tackifier and 5-15% of a plasticizer, wherein the base material is a phosphate compound; the curing agent is one or more of zinc oxide, aluminum oxide, copper oxide and magnesium oxide; the retarder is one or more of organic polymers which resist high temperatures

All documents cited herein are incorporated by reference.

None of the above cited documents, alone or in combination satisfy the need for a device or method for sealing leaks that occur between overlapping panels of a bolted tank, or around the bolts that are installed to keep overlapping panels of a bolted tank together. Hence, there remains a need for a device and method that can be used to seal such leaks, particularly a device and method that can be used without emptying the liquid contained in the bolted tank.

### BRIEF SUMMARY

It is an object of the invention to provide an injector assembly for sealing leaks on bolted tanks and method of using same.

In accordance with an aspect of the invention there is provided an injector assembly device for sealing leaks in bolted tanks, said device comprising: an essentially solid sleeve having a lower surface, an upper surface, an outer cylindrical edge and a central axis; an inner threaded channel extending from said lower surface into said essentially solid sleeve along said central axis; a circular channel embedded into said lower surface encompassing said inner threaded channel and an o-ring fitted within said circular channel; a caulking reservoir formed in said lower surface between said circular channel and said inner threaded channel, said caulking reservoir encompassing and in fluid communication with said inner threaded channel; a caulking channel extending from a caulking entry position on said upper surface to said caulking reservoir; and a grease nipple attached to said caulking entry position in fluid communication with said caulking channel.

In accordance with another embodiment of the invention there is provided a device as described above, wherein said inner threaded channel extends from said lower surface to said upper surface.

In accordance with another aspect of the invention there is provided a method of sealing a leak on a bolted tank using the device of as described above, said method comprising: removing a nut from a bolt that is extends through a first hole on a first tank panel and a second hole on a second tank panel of said bolted tank; screwing said inner threaded channel of said device onto said bolt until said o-ring forms a seal with said tank; attaching a caulking gun to said grease nipple; pumping sealant from said caulking gun into said caulking channel until said sealant fills said caulking reservoir; continuing to pump said caulking gun until said sealant exudes around said bolt, through said first hole, into a gap between said first tank panel, through said second hole and around a bolt head; and disconnecting said caulking gun and unscrewing said inner threaded channel of said device from said bolt, and reapplying said nut.

In accordance with another embodiment of the invention there is provided the method as described above, wherein a notch is cut into said exposed end of said bolt and a screwdriver is inserted into said inner threaded channel that extends from said lower surface to said upper surface to engage with said notch.

In accordance with another aspect of the invention there is provided a kit for sealing a leak on a bolted tank, said kit comprising one or more devices of as described above, one or more o-rings, and optional instructions for use.

The advantages and features of the present invention will become better understood with reference to the following more detailed description and claims taken in conjunction with the accompanying drawings in which like elements are identified with like symbols.

### BRIEF DESCRIPTION OF THE DRAWINGS

To easily identify the discussion of any particular element or act, the most significant digit or digits in a reference number refer to the figure number in which that element is first introduced.

FIG. 1 illustrates a cross-sectional aspect of the device in accordance with one embodiment of the invention.

FIG. 2 illustrates a perspective aspect of the upper surface of the device in accordance with one embodiment of the invention.

FIG. 3 illustrates a perspective aspect of the lower surface of the device in accordance with one embodiment of the invention.

FIGS. 4A and 4B illustrate inner and outer aspects of the tank prior to use of the device in accordance with one embodiment of the invention.

FIGS. 5A and 5B illustrate inner and outer aspects of the tank after use of the device in accordance with one embodiment of the invention.

FIG. 6 illustrates a cross-sectional aspect of the subject matter in accordance with one embodiment of the invention.

FIG. 7 illustrates a cross-sectional aspect of the subject matter in accordance with one embodiment of the invention.

FIG. 8 illustrates an aspect of the subject matter in accordance with one embodiment.

### DETAILED DESCRIPTION

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

The injector assembly device disclosed herein provides a rapid and inexpensive way to seal leaks in bolted tanks, without having to drain the tank. Leaks occur over time either between the overlapping tank panels, around the tank bolts or a combination of both. It is a very costly and time-consuming process to drain tanks in order to repair such leaks. The device disclosed can therefore find application specifically in field of bolted tanks, but also in numerous different applications when a water tight seal is required between two pieces of material that are bolted together.

Various embodiments of the invention comprise a mechanism for attaching the device to a protruding bolt thread on the outer side of a bolted tank after removal of the nut. The device also has an attachment member for a caulking or sealant gun, such as a grease nipple. When the device has been secured to the protruding bolt thread, the sealant can be pumped around the protruding bolt thread. An appropriately positioned sealing member, such as an o-ring, causes the sealant to migrate through along the protruding bolt thread, through the bolt holes in the tank panels, sealing any gaps around the bolt or between the overlapping tank panels.

The grease nipple fitting on the currently disclosed injection assembly is typical of those known to workers skilled in the field. Grease fittings are permanently installed by either a thread, taper thread or straight push-fit (‘hammer in’) arrangement, leaving a nipple connection that a grease gun attaches to. The pressure supplied by the grease gun forces a small captive bearing ball in the fitting to move back against the force of its retaining spring. The arrangement is thus essentially a valve that opens under pressure to allow lubricant to pass through a channel and be forced into the voids of the bearing. When the pressure ceases, the ball returns to its closed position. The ball excludes dirt and functions as a check valve to prevent grease escaping back out of the fitting. The ball is almost flush with the surface of the fitting so that it can be wiped clean to reduce the amount of debris carried with the grease into the bearing.

The device is typically fabricated from metals, alloys or hardened plastics.

Metals are selected from the group including, but not limited to: steel; stainless steel; aluminum; brass; copper; and titanium.

Alloys are selected from the group including, but not limited to: Carp 49; Greek Ascoloy; Hastelloy; Hymu 80; and Nitronic 60.

Plastics are selected from the group including, but not limited to: Acetal; Delrin; Extruded Nylon; PEEK; PTFE; Teflon; PVC; ULTEM; and UHMW.

Specific details relating to devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

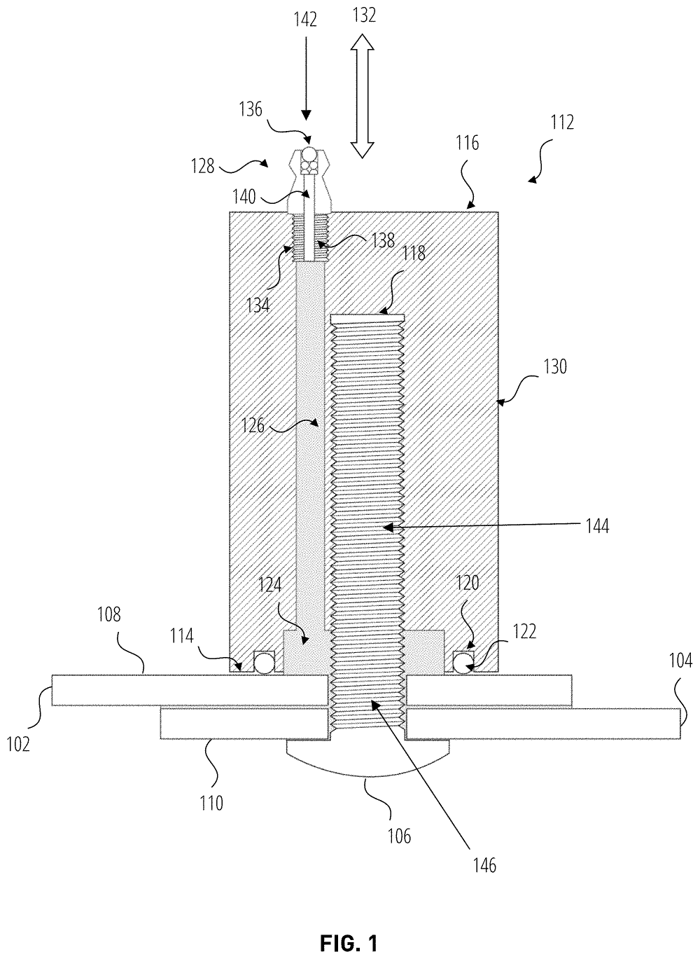

FIG. 1 shows a cross-sectional view of an embodiment of the injection assembly device.

A bolted tank comprises numerous panels that are overlapped and bolted together. The bolt heads are installed from the inner side of the tank, projecting through cooperating holes drilled in the overlapping panels. A combination of washers and silicone is typically used to render the seals around the bolt watertight prior to applying a securing nut to the section of bolt that protrudes from the outer side of the tank when the tank is constructed. Over time, leaks may develop around the bolts and between the overlapping tank panels.

The embodiment of the invention illustrated in FIG. 1 shows a connection between a first tank panel 102 and a second tank panel 104 after the securing nut has been removed. The tank bolt head 106 extends from the inner tank surface 110 to the outer tank surface 108.

The injection assembly device comprises an essentially solid sleeve 112, having an outer cylindrical edge 130, a lower surface 114 and an upper surface 116. An inner threaded channel 118 runs from the lower surface 114 along a central axis 132 into the essentially solid sleeve 112. The inner threaded channel 118 is sized and configured to cooperate with the protruding bolt thread 144 including the threaded section to be sealed 146.

A circular channel 120 is embedded in the lower surface 114 sized and proportioned to accommodate a sealing ring such as an o-ring 122. The circular channel 120 encompasses the inner threaded channel 118.

A caulking reservoir 124 is formed in the lower surface 114 between the circular channel 120 and the inner threaded channel 118. The caulking reservoir 124 encompasses and is in fluid communication with the inner threaded channel 118 and is situated within the circular channel 120.

A caulking channel 126 extends from a caulking entry position 142 on the upper surface 116 to the caulking reservoir 124. A grease nipple 128 being attached to the caulking entry position 142, which is in fluid communication with the caulking channel 126. The grease nipple 128 typically has grease nipple bearings 136 at the caulking entry position 142 and a grease nipple caulking tube 140 in fluid communication with the caulking channel 126. The grease nipple 128 typically has a lower outer threaded section 138 that cooperates with an upper threaded section 134 formed in the essentially solid sleeve 112 at the upper surface 116.

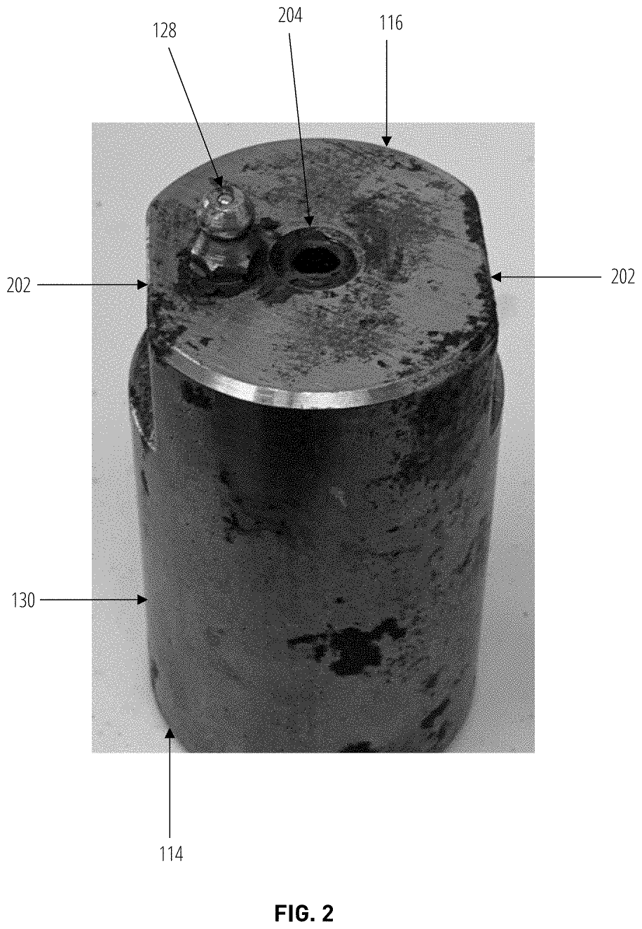

FIG. 2 shows a top perspective view of an embodiment of the invention.

In some embodiments of the invention, the outer cylindrical edge 130 has two opposing flattened sections 202 situated in close proximity to the upper surface 116. In most situations, the injection assembly device can be manually tightened onto the protruding bolt section. Occasionally, on old or worn bolts it may be necessary to apply greater torquing force than can be achieved manually. The size and dimensions of the opposing flattened sections 202 are such that a wrench can be attached to the outer cylindrical edge 130 to assist in connecting the inner threaded channel 118 (not shown) located at the lower surface 114 to the protruding tank bolt head 106 (also not shown).

In some embodiments of the invention, the inner threaded channel 118 extends axially all the way through the essentially solid sleeve 112 and out through the upper surface 116 by way of an exit port 204. The function of the exit port 204 is to accommodate a screwdriver that can be inserted down the inner threaded channel 118 into a pre-formed notch on the bolt to prevent the bolt from spinning during application or removal of the device. Additionally, the exit port can assist with cleaning the caulking or sealant from the device after use.

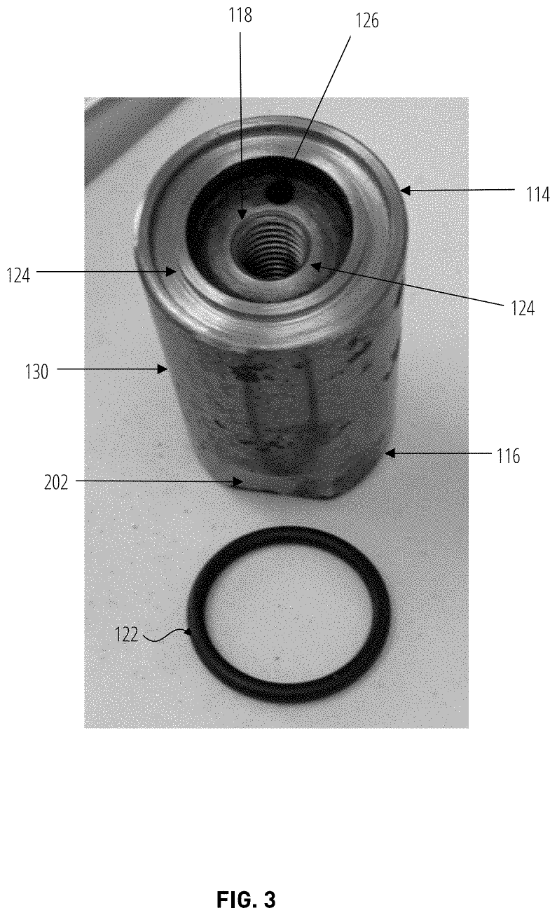

FIG. 3 shows a bottom perspective view of an embodiment of the invention.

The outer cylindrical edge 130 having two opposing flattened sections 202 situated in close proximity to the upper surface 116 can again be seen. The lower surface 114 can however be seen in greater detail in this figure. The inner threaded channel 118 can be seen centrally positioned and encompassed by the caulking reservoir 124. The o-ring 122 that is sized and proportioned to fit inside the caulking reservoir 124 can be seen. The lower end of the caulking channel 126 can be seen in fluid communication with the caulking reservoir 124.

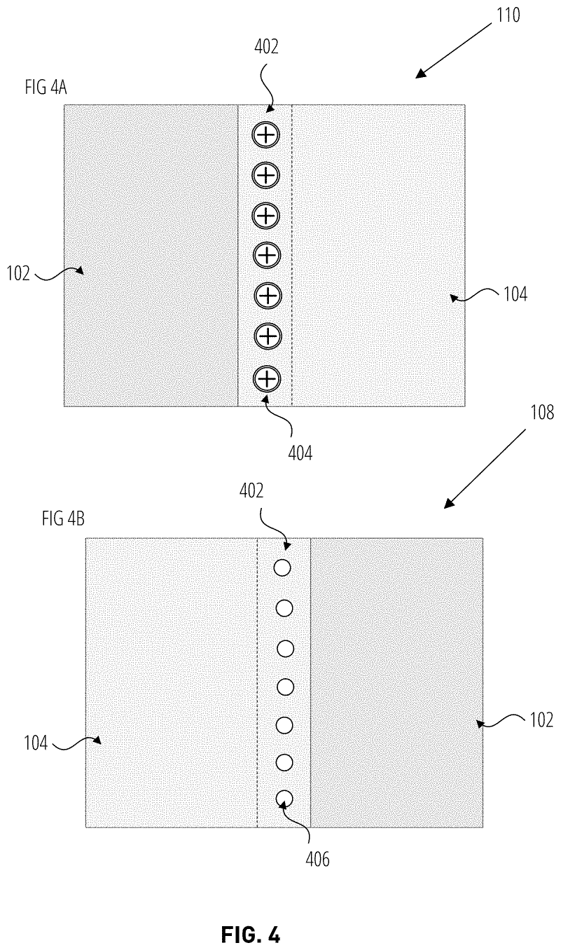

FIGS. 4A and 4B show interior and exterior view of a bolted tank bolt head 106 prior to use of an embodiment of the invention. The nuts that hold the tank bolt heads 106 in place have been removed.

FIG. 4A illustrates an inner tank surface 110 having a series of bolt heads 404 installed to connect a first tank panel 102 and a second tank panel 104 and an overlapping section 402.

FIG. 4B illustrates an outer tank surface 108 having a series of protruding bolts 406 installed to connect a first tank panel 102 and a second tank panel 104 at an overlapping section 402.

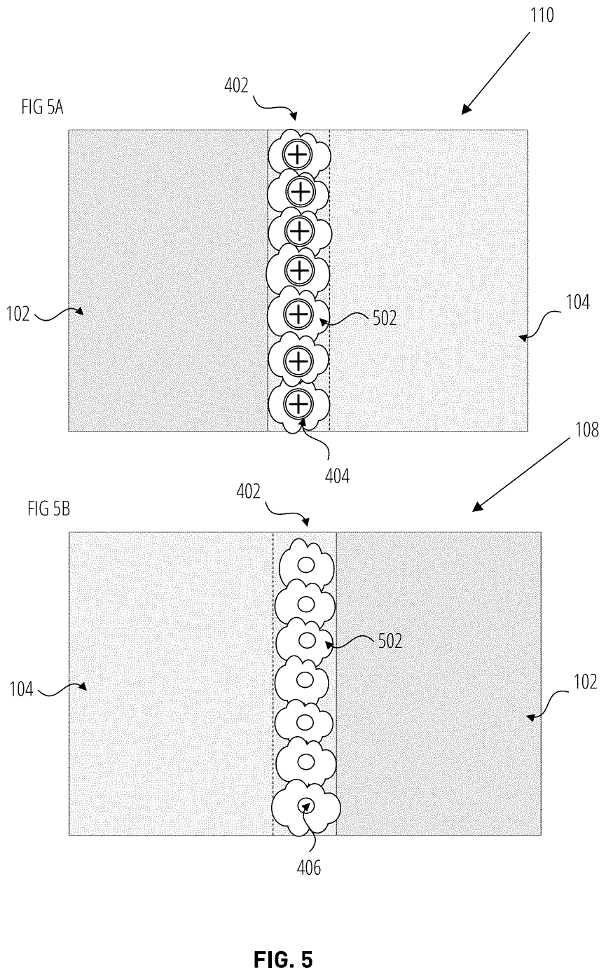

FIGS. 5A and 5B show interior and exterior view of a bolted tank after use of an embodiment of the invention. The bolted tank has drilled panels that were overlapped, with the drilled bolt holes aligned to receive a bolt. The nuts, that hold the tank bolts and tank bolt heads 106 in place, have been removed and not reinstalled.

FIG. 5A illustrates an inner tank surface 110 having a series of bolt heads 404 installed to connect a first tank panel 102 and a second tank panel 104 and an overlapping section 402. After attaching the injector assembly to the inner threaded channel 118, the caulking gun is attached to the grease nipple 128 and used to drive the sealant 502 into the caulking reservoir 124. Continued pumping of the caulking gun causes the sealant 502 to exude around the bolt, through the hole in the first tank panel 102. The sealant 502 continues to exude into the gap between the first tank panel 102 and the second tank panel 104, then through the hole in the second tank panel 104 and around thread and tank bolt head 106 situated on the inner tank surface 110.

FIG. 5B illustrates an outer tank surface 108 having a series of protruding bolts 406 installed to connect a first tank panel 102 and a second tank panel 104 at an overlapping section 402. After a sufficient amount of sealant 502 has been pumped through the injector assembly into individual or a series of bolt heads 404 and it has exuded around the protruding bolt threads 144, around the threaded section to be sealed 146, in the gap between the first tank panel 102 and the second tank panel 104, and around the tank bolt head 106—the tank leak is affectively sealed as shown in FIGS. 5A and 5B.

In some instances, when the entire overlapping join is leaking, is may be necessary to seal all of the bolts holding the panels together—as illustrated in FIGS. 4A and 4B and FIGS. 5A and 5B.

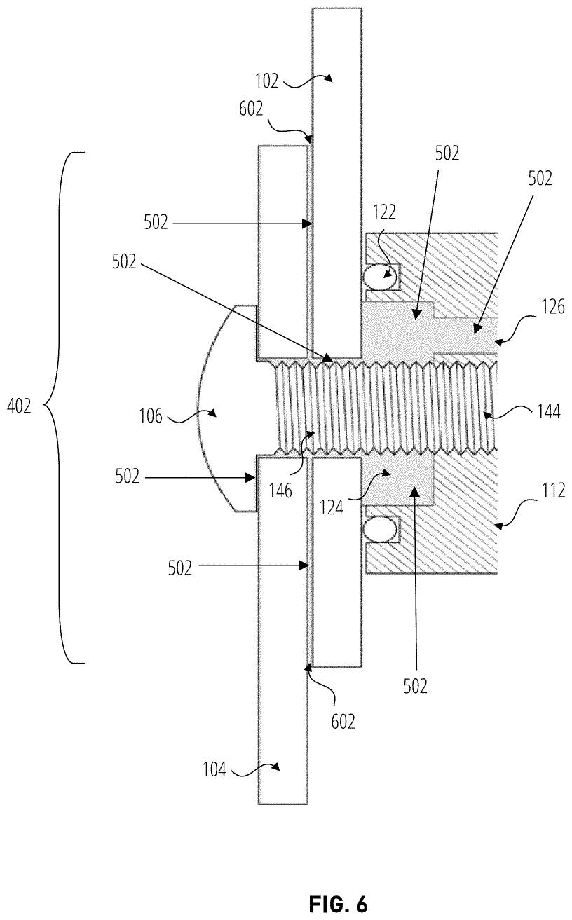

FIG. 6 shows a close-up view of a section of the tank bolt close to a tank overlapping section 402.

The first tank panel 102 and second tank panel 104 can be seen, with the essentially solid sleeve 112 of the injector assembly in position after the sealant 502 has been pumped into place. The o-ring 122 can be seen in contact with the first tank panel 102 and the forming a liquid tight seal. The caulking channel 126 and caulking reservoir 124 can be seen to be full of sealant 502.

The sealant 502 can be seen to have been pumped into the threaded section to be sealed 146, through the holes in the panels, into the gaps 602 between the first tank panel 102 and the second tank panel 104 and between the tank bolt head 106 and the second tank panel 104.

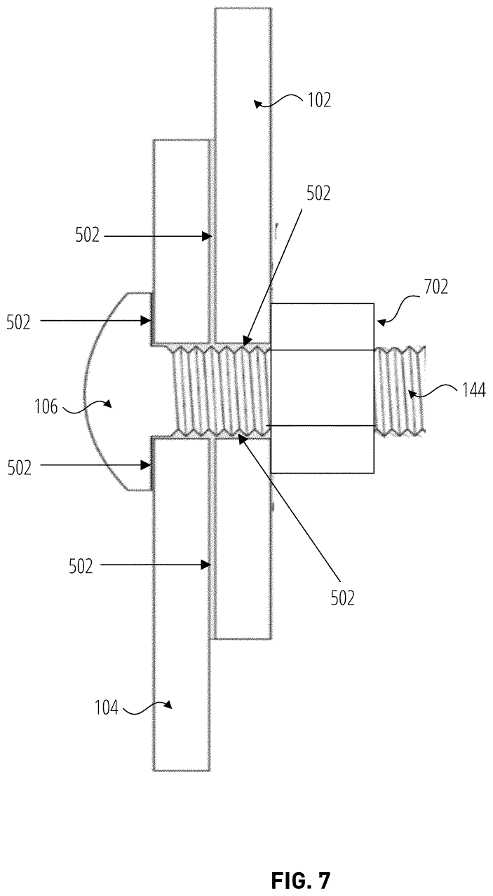

FIG. 7 shows a close-up view of a section of the tank bolt close to a tank overlapping section 402 after the essentially solid sleeve 112 of the injector assembly has been removed and replaced with a nut 702.

As shown in FIG. 6, the sealant 502 can be seen to remain in the threaded section to be sealed 146 and in the gaps 602 between the first tank panel 102 and the second tank panel 104 and between the tank bolt head 106 and the second tank panel 104—thereby achieving a water tight seal between all surfaces and components that were leaking.

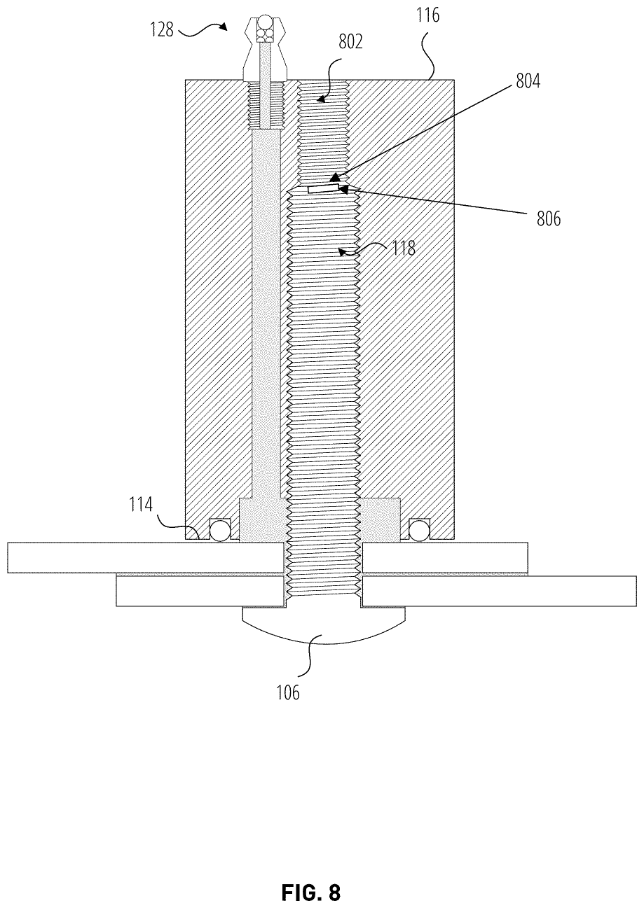

FIG. 8 shows an alternative embodiment of the invention. The parts of this figure are as shown in FIG. 1. However, this embodiment additionally has an inner threaded channel 118 that effectively extends from the lower surface 114 of the device to the upper surface 116. An exit port 802 connects the inner threaded channel 118 to the upper surface 116. The exit port 802 may be of the same or different diameter to the inner threaded channel 118.

The function of the exit port 802 is two-fold. Firstly, it provides access to the bolt end 806. In some instances, the bolt may rotate when applying or removing the device to or from the bolt. In order to be able to prevent this problematic rotation, a notch is cut into the bolt end 806 prior to engaging the device onto the device. A flat head screw driver can then be inserted into the exit port 802 and fitted into the notch 804 to hold the bolt steady and prevent the rotation. Secondly, the exit port 204 assists in the cleaning of the calking or sealant 502 from the device after use.

The method of sealing a leak on a bolted tank using embodiments of the device can be achieved after removal of the nut 702 from the protruding bolt thread 144. In some instances, in the case of old, worn or damaged protruding bolt threads 144, it may be necessary to run a thread chaser up and down the protruding bolt thread 144 after removing the nut 702. This will clean up any burrs or knurls on the threaded section.

It is often advisable to cut a notch in the end of the bolt prior to applying the device to the protruding bolt. Then it is possible to insert a screwdriver into the device through the exit port, down into the inner threaded channel 118. In this embodiment of the invention, the screwdriver that can be inserted into the pre-formed notch on the bolt to prevent the bolt from spinning during application or removal of the device. Additionally, the exit port can assist with cleaning the caulking or sealant from the device after use.

When the protruding bolt thread 144, that extends through cooperating holes in the overlapping panels, is exposed and clean, then the injection assembly can be attached. This is typically achieved by the application of manual force, screwing the inner threaded channel 118 of the essentially solid sleeve 112 onto the protruding bolt thread 144 until a snug fit between the outer tank surface 108 and the o-ring 122 is achieved. In some instances, if there is resistance between the inner threaded channel 118 and the protruding bolt thread 144, a wrench may be applied to the opposing flattened sections 202 to achieve the snug fit.

When the injection assembly device is securely attached to the protruding bolt thread 144, a caulking gun is connected to the grease nipple 128. Sealant 502 from the caulking gun is pumped down the caulking channel 126 into the caulking reservoir 124. Continued pumping of the caulking gun causes the sealant to exudes around the threaded section to be sealed 146, through the bolt hole on first tank panel 102, into the gap 602 between the first tank panel and the second tank panel 104, through the hole in the second tank panel 104 and around the tank bolt head 106.

When the sealant has sealed all of the necessary spaces and gaps 602, the caulking gun is disconnected from the injection assembly device. The device is then disconnected from the protruding bolt thread 144 by unscrewing the inner threaded channel 118 from the protruding bolt thread 144. The nut 702 is then reapplied to the protruding bolt thread 144 and tightened.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. An injector assembly device for sealing leaks in bolted tanks, said device comprising:
an essentially solid sleeve having a lower surface, an upper surface, an outer cylindrical edge and a central axis;
an inner threaded channel extending from said lower surface into said essentially solid sleeve along said central axis;
a circular channel embedded into said lower surface encompassing said inner threaded channel and an o-ring fitted within said circular channel;
a caulking reservoir formed in said lower surface between said circular channel and said inner threaded channel, said caulking reservoir encompassing and in fluid communication with said inner threaded channel;
a caulking channel extending from a caulking entry position on said upper surface to said caulking reservoir; and
a grease nipple attached to said caulking entry position in fluid communication with said caulking channel.

2. The device of claim 1, wherein said inner threaded channel extends from said lower surface to said upper surface.

3. The device of claim 2, wherein said caulking entry position comprises an upper threaded section.

4. The device of claim 3, wherein said grease nipple comprises an upper bearing section, a lower outer threaded section, sized and configured to accommodate said upper threaded section, and a caulking tube extending between said upper bearing section and said caulking channel.

5. The device of claim 2, wherein said upper bearing section is sized and configured to cooperate with a caulking gun.

6. The device of claim 2, wherein said an inner threaded channel extends from said lower surface through said essentially solid sleeve along said central axis and out through said upper surface.

7. The device of claim 2, wherein said outer cylindrical edge has two opposing flattened surfaces sized and configured to cooperate with a wrench.

8. The device of claim 7, wherein said two opposing flattened surfaces are positioned in close approximation to said upper surface.

9. The device of claim 2, wherein said inner threaded channel is sized and configured to accommodate a tank bolt.

10. A method of sealing a leak on a bolted tank using the device of claim 1, said method comprising:
removing a nut from a bolt, said bolt having an exposed end and a head situated within said bolted tank, said bolt extends through a first hole on a first tank panel and a second hole on a second tank panel of said bolted tank;
screwing said inner threaded channel of said device onto said bolt until said o-ring forms a seal with said tank;
attaching a caulking gun to said grease nipple;
pumping sealant from said caulking gun into said caulking channel until said sealant fills said caulking reservoir;
continuing to pump said caulking gun until said sealant exudes around said bolt, through said first hole, into a gap between said first tank panel, through said second hole and around a bolt head; and
disconnecting said caulking gun and unscrewing said inner threaded channel of said device from said bolt, and reapplying said nut.

11. The method of claim 10, said method additionally comprising threading a thread chaser up and down said bolt after removing said nut.

12. A method of sealing a leak on a bolted tank using the device of claim 2, said method comprising:
removing a nut from a bolt, said bolt having an exposed end and a head situated within said bolted tank, said bolt extends through a first hole on a first tank panel and a second hole on a second tank panel of said bolted tank;
screwing said inner threaded channel of said device onto said bolt until said o-ring forms a seal with said tank;
attaching a caulking gun to said grease nipple;
pumping sealant from said caulking gun into said caulking channel until said sealant fills said caulking reservoir;
continuing to pump said caulking gun until said sealant exudes around said bolt, through said first hole, into a gap between said first tank panel, through said second hole and around a bolt head; and
disconnecting said caulking gun and unscrewing said inner threaded channel of said device from said bolt, and reapplying said nut.

13. The method of claim 11, wherein a notch is cut into said exposed end of said bolt.

14. The method of claim 13, additionally comprising inserting a screwdriver into said inner threaded channel that extends from said lower surface to said upper surface to engage with said notch.

15. The method of claim 10, wherein said sealant is Manus or KBA sealant.

16. The method of claim 12, wherein said sealant is Manus or KBA sealant.

17. A kit for sealing a leak on a bolted tank, said kit comprising one or more devices of claim 1, one or more o-rings, and instructions for use.

18. The kit of claim 17, wherein said one or more devices have different diameter inner threaded channels.

19. A kit for sealing a leak on a bolted tank, said kit comprising one or more devices of claim 2, one or more o-rings, and instructions for use.

20. The kit of claim 19, wherein said one or more devices have different diameter inner threaded channels.
